(19) United States
(12) Patent Application Publication
(10) Pub. No.: US 2018/0366092 A1
(43) Pub. Date: Dec. 20, 2018

(54) VEHICLE WINDOW LOCATOR SYSTEM

(71) Applicant: Ken L. Allmacher, Macomb Township, MI (US)

(72) Inventor: Ken L. Allmacher, Macomb Township, MI (US)

(21) Appl. No.: 16/009,500

(22) Filed: Jun. 15, 2018

Related U.S. Application Data
(60) Provisional application No. 62/520,719, filed on Jun. 16, 2017.

(51) Int. Cl. G09G 5/38; G06T 3/20; G06Q 20/18

(52) U.S. Cl. CPC G09G 5/38; G06T 3/20; G06Q 20/18; G09G 2340/0464; G09G 2380/10; G09G 2340/14; G09G 2356/00

(57) ABSTRACT

A vehicle window locator system includes a sensor operable to determine a vehicle reference and a user interface in communication with the sensor, the user interface movable with respect to the vehicle reference.

The present disclosure claims priority to U.S. Provisional Patent Disclosure Ser. No. 62/520,719, filed Jun. 16, 2017.

### BACKGROUND

The present disclosure relates to a vehicle window locator, more particularly, to a locator for a kiosk.

Consumers that drive different size vehicles often have difficulty in accessing a payment kiosk such as a bank, car wash, fast food restaurant, etc. Conventional drive up kiosks are set to a specific height which may require consumers to unbuckle seat belts and lean out of their vehicle to interact with the kiosk. In some cases, the consumer exits the vehicle to make their transaction. This severely slows down the transaction and may be unsafe in some situations.

### SUMMARY

A vehicle window locator system according to one disclosed non-limiting embodiment of the present disclosure includes a sensor operable to determine a vehicle reference and a user interface in communication with the sensor, the user interface movable with respect to the vehicle reference.

A further aspect of the present disclosure includes that the vehicle reference comprises a hood line.

A further aspect of the present disclosure includes that the vehicle reference comprises a roof line.

A further aspect of the present disclosure includes that the sensor is at least one of a photo eyes, Sonar, LIDAR, Radar, and a limit switch.

A further aspect of the present disclosure includes that the sensor is movable with the user interface.

A further aspect of the present disclosure includes that the user interface is located within a kiosk for access by a user in a vehicle.

A further aspect of the present disclosure includes that the user interface moves with respect to a stationary cabinet that at least partially forms the kiosk.

A further aspect of the present disclosure includes that the sensor is arranged adjacent the user interface and defines a view toward a side of a vehicle.

A further aspect of the present disclosure includes that the sensor is arranged adjacent the user interface and defines a view toward a top of a vehicle.

A further aspect of the present disclosure includes that the sensor includes a multiple of vertically arranged sensors.

A method for positioning a user interface with respect to a vehicle according to one disclosed non-limiting embodiment of the present disclosure includes determining a vehicle reference; and moving a user interface with respect to the vehicle reference such that the user interface is aligned with a vehicle window opening.

A further aspect of the present disclosure includes that determining the vehicle reference comprises moving a sensor that identifies the vehicle reference and moving the user interface in coordination with the user interface.

A further aspect of the present disclosure includes that determining the vehicle reference comprises moving a sensor that follows the vehicle reference and moving the user interface in coordination with the user interface.

A further aspect of the present disclosure includes that the vehicle reference comprises a hood line.

A further aspect of the present disclosure includes that determining the vehicle reference comprises at least one of visual, infrared, sonar, and radar.

A further aspect of the present disclosure includes that moving the user interface comprises moving the user interface with respect to a stationary cabinet that at least partially forms a kiosk.

The foregoing features and elements may be combined in various combinations without exclusivity, unless expressly indicated otherwise. These features and elements as well as the operation of the invention will become more apparent in light of the following description and the accompanying drawings. It should be appreciated; however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of a vehicle window locator system.

FIG. 2 is a schematic cross-section of a vehicle window locator system in a first position.

FIG. 3 is a schematic cross-section of a vehicle window locator system in a second position.

FIG. 4 is a face view of the vehicle window locator system according to one disclosed non-limiting embodiment with a sensor on an extension.

FIG. 5 is a top view of the vehicle window locator system.

FIG. 6 is a face view of the vehicle window locator system according to one disclosed non-limiting embodiment with a multiple of vertically arranged fixed sensors.

FIG. 7 is a perspective view of the vehicle window locator system according to one disclosed non-limiting embodiment with a fixed sensor on a kiosk overhang directed at a top view of the vehicle.

FIG. 8 is a flow diagram of a method of operating the vehicle window locator system.

FIG. 9 is a schematic cross-section of a vehicle window locator system in a first position.

FIG. 10 is a schematic cross-section of a vehicle window locator system in a second position.

### DETAILED DESCRIPTION

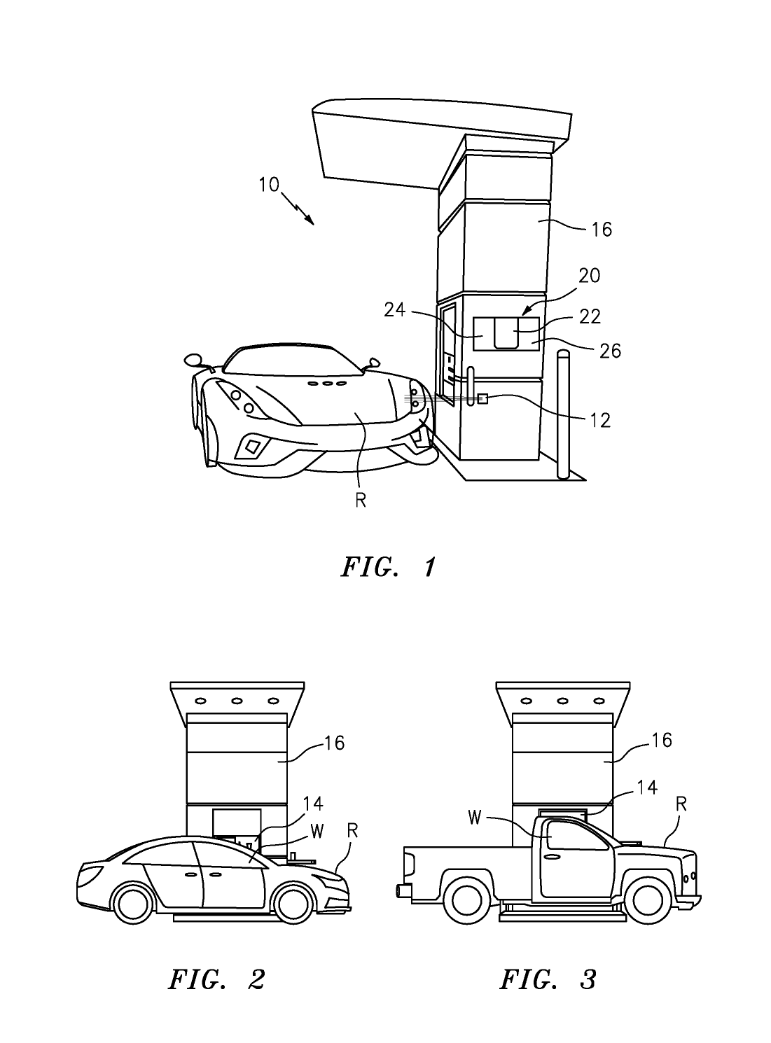

FIG. 1 schematically illustrates a vehicle window locator system 10. The system 10 generally includes a sensor 12 operable to determine a vehicle reference “R”, and a user interface 14 in communication with the sensor 12. The user interface 14 is movable with respect to the vehicle reference “R” to position the user interface 14 in response to a control system 20. The vehicle reference “R” may include, for example, a vehicle hood line, roofline to position the user interface 14 with respect to a vehicle window opening W (FIGS. 2 and 3) for easy access by the vehicle driver. The user interface 14 may be a touch screen, payment device or other interaction system located within a kiosk 16 when interacting with, for example, an ATM, a drive-up ordering system, parking lot, a car-wash or other transaction that occurs from within a vehicle.

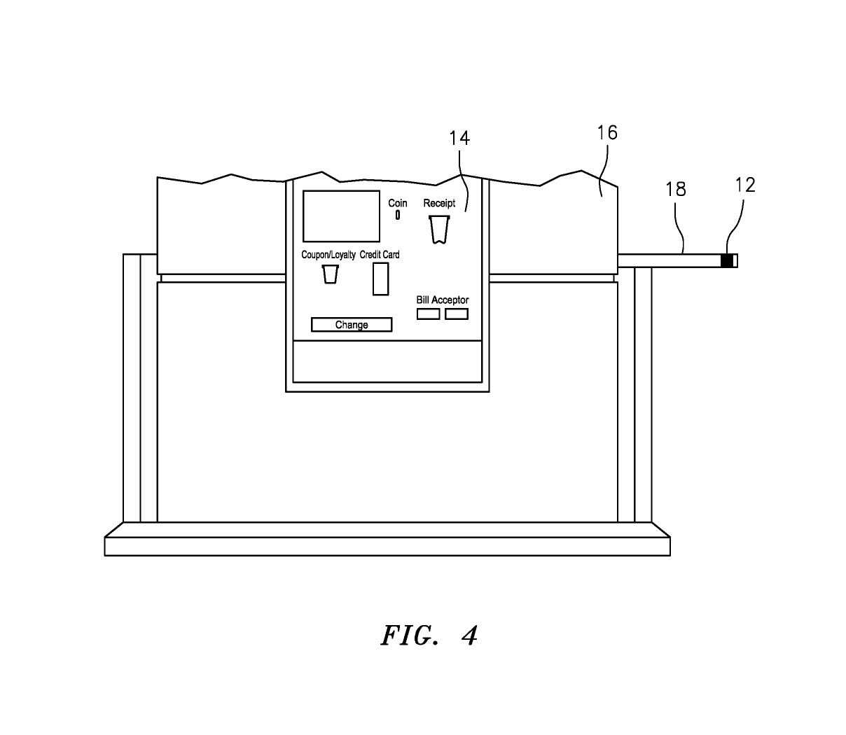

The sensor 12 may be at least one of a photo eye, sonar, LIDAR, radar, or other sensor which can identify the vehicle reference “R”. The sensor 12 may be located on an extension 18 (FIG. 4), that moves as the vehicle reference “R” moves with respect to the vehicle as the vehicle pulls forward toward the kiosk 16.

As the sensor 12 adjusts to the vehicle reference “R”, the user interface 14 likewise moves in coordination therewith so that once the sensor 12 follows the vehicle reference “R” to reach the window opening “W”, the user interface 14 likewise reaches a proper height relative to the window opening “W”. A predetermined offset distance (e.g., six inches above the vehicle reference “R”) may be defined between the position of the sensor 12 and the user interface 14 so that the user interface 14 is best positioned for access. Virtually every hood line on all makes and models of vehicles matches the bottom of a side window within a couple of inches. In other embodiment, side window location may be referenced to a vehicle roof line or other vehicle component which provides a reference to the vehicle window sill.

Alternatively, the sensor 12 may include a multiple of fixed vertically arranged sensors 12a (FIG. 6) that do not move. One or more of the vertically arranged sensors 12a detect the vehicle reference “R”, such that the user interface 14 likewise moves in coordination therewith.

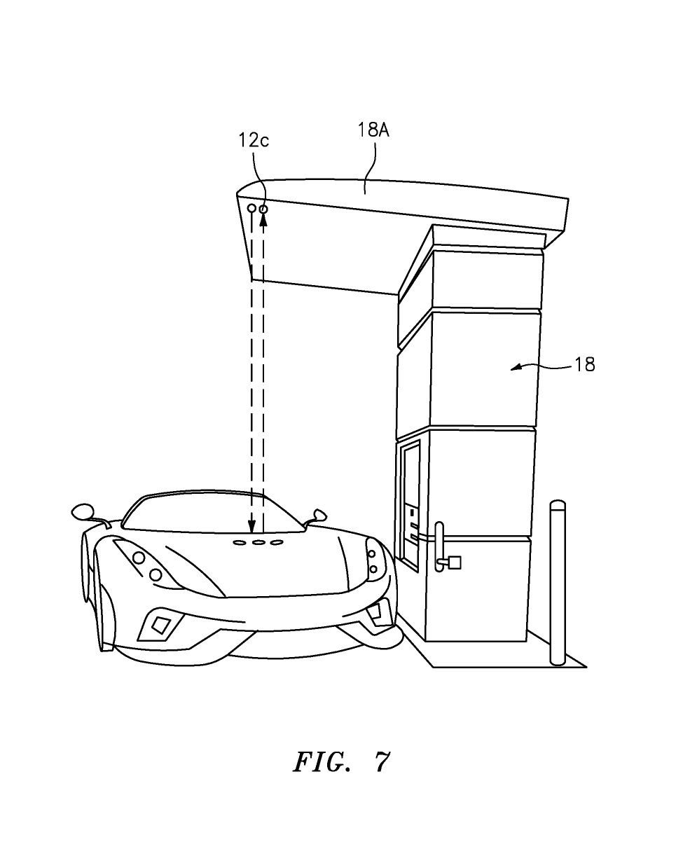

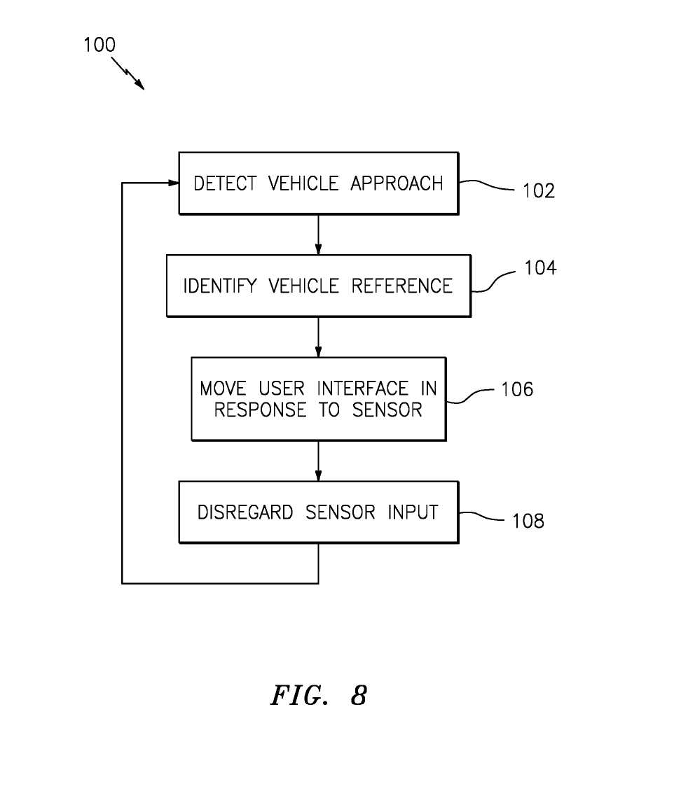

Alternatively, the sensor 12c (FIG. 7) may be located on an overhang 18A adjacent the user interface 14 to define a view toward a top of the vehicle. The sensor 12c detects the vehicle reference “R” such that the user interface 14 moves in response to a height of the vehicle reference “R” which, in this embodiment is a distance to the hood line.

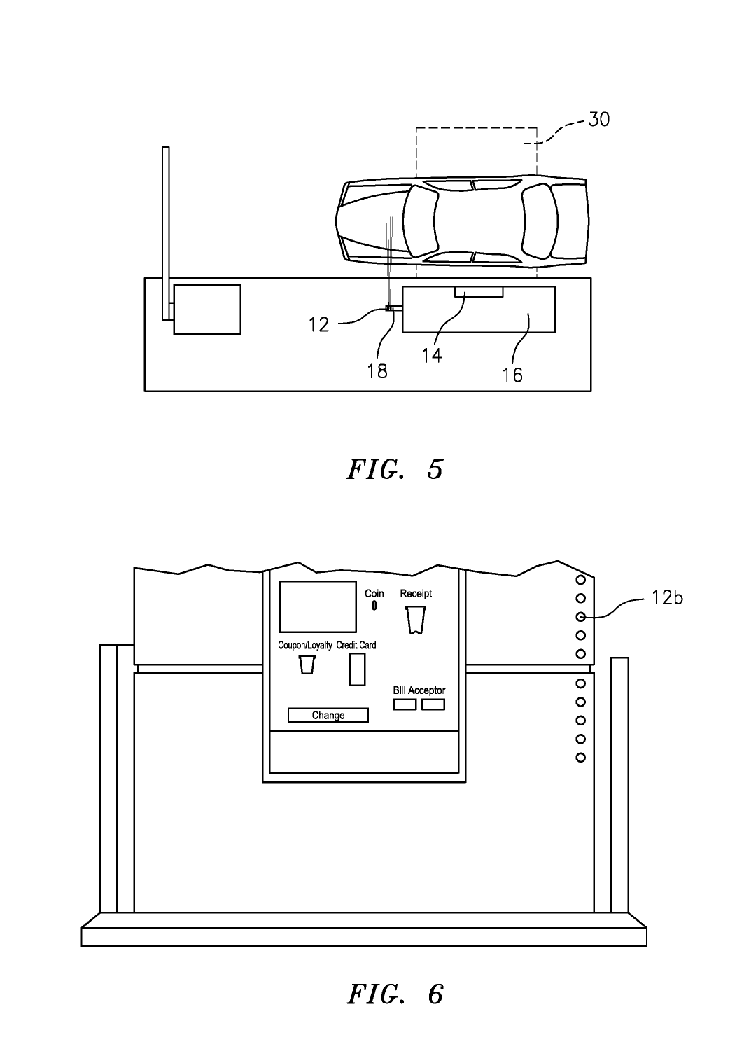

The control system 20 may include other hardware, firmware, and/or software components that are configured to perform the functions disclosed herein. The control system 20 may also be in communication with other systems via a communication network. The control system 20 may include at least one processor 22, a memory 24, and an input/output (I/O) subsystem 26. The control system 20 may be embodied as any type of computing device, integrated circuit, or other electronic control. The processor 22 and the I/O subsystem 26 are communicatively coupled to the memory 24. The memory 24 may be embodied as any type of computer memory device (e.g., various forms of random access memory). The I/O subsystem 26 may also be communicatively coupled to a number of hardware, firmware, and/or software components, including the sensor 12, the user interface 14, a vehicle detector 30 (FIG. 5) such as a magnetic ground loop, photo eye or other indicator that senses the presence of the vehicle on approach to the kiosk 16. Once the vehicle is sensed, the control system 20 begins operation of the method 100 (FIG. 8).

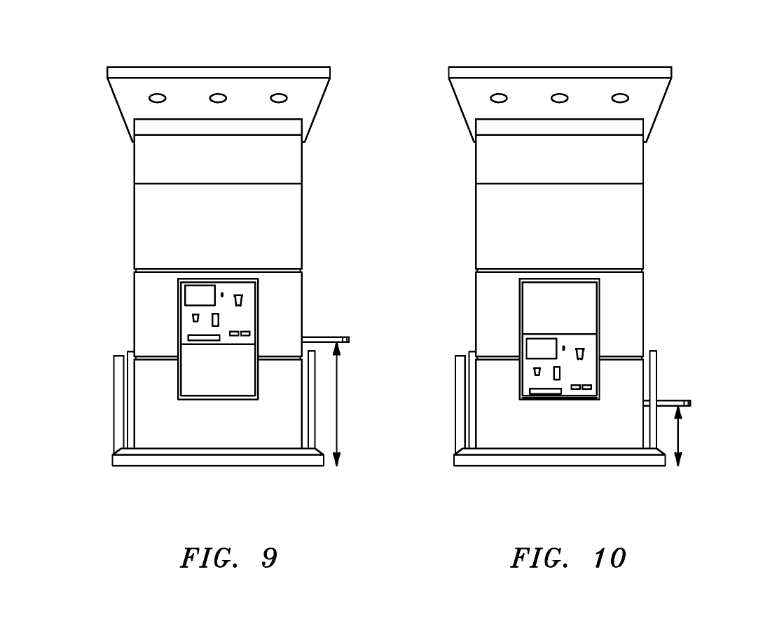

With reference to FIG. 8, one disclosed non-limiting embodiment of a method 100 for positioning a user interface with respect to a vehicle initially includes transaction commencement in response to approach (step 102) of a vehicle to the kiosk 16 by the vehicle detector 30 (FIG. 5) that senses the presence of the vehicle. The sensor 12 reads the vehicle and determines if the user interface 14 needs to go up or down. If the sensor 12 identifies the vehicle (is initially below the vehicle reference “R”; FIG. 9) as the vehicle approaches then the sensor 12 will move up until the vehicle reference “R” is detected. If the sensor 12 does not detect anything as the vehicle approaches (is initially above the vehicle reference “R”; FIG. 10), then the sensor 12 will move down until the vehicle reference “R” is detected.

Once the vehicle approach is confirmed, the sensor 12 then identifies (step 104) the vehicle reference “R” to follow the vehicle reference “R”. The height of the vehicle reference “R” is used as a reference to move the sensor 12 and determine the location of the car window “W”. In response to movement of the sensor 12, the user interface 14 is moved (step 106) in coordination therewith.

Once the transaction is complete, the software may disregard further input from the sensor 12 for a time period (step 108), e.g., 15 seconds, to permit the vehicle to pull forward, and the next vehicle can then approach the kiosk and the cycle repeats.

Although particular sequences are shown, described, and claimed, it should be understood that steps may be performed in any order, separated or combined unless otherwise indicated and will still benefit from the present disclosure.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that relative positional terms such as “forward”, “aft”, “upper”, “lower”, “above”, “below”, and the like are with reference to the normal operational attitude of the vehicle and should not be considered otherwise limiting.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be appreciated that steps may be performed in any order, separated or combined, unless otherwise indicated, and will still benefit from the present disclosure.

The foregoing description is exemplary rather than defined by the limitations within. Various non-limiting embodiments are disclosed herein; however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed is:

1. A vehicle window locator system, comprising:
a sensor operable to determine a vehicle reference; and
a user interface in communication with the sensor, the user interface movable with respect to the vehicle reference.

2. The system as recited in claim 1, wherein the vehicle reference comprises a hood line.

3. The system as recited in claim 1, wherein the vehicle reference comprises a roof line.

4. The system as recited in claim 1, wherein the sensor is at least one of a photo eyes, Sonar, LIDAR, Radar, and a limit switch.

5. The system as recited in claim 1, wherein the sensor is movable with the user interface.

6. The system as recited in claim 1, wherein the user interface is located within a kiosk for access by a user in a vehicle.

7. The system as recited in claim 6, wherein the user interface moves with respect to a stationary cabinet that at least partially forms the kiosk.

8. The system as recited in claim 6 wherein the sensor is arranged adjacent the user interface and defines a view toward a side of a vehicle.

9. The system as recited in claim 6, wherein the sensor is arranged adjacent the user interface and defines a view toward a top of a vehicle.

10. The system as recited in claim 1, wherein the sensor includes a multiple of vertically arranged sensors.

11. A method for positioning a user interface with respect to a vehicle, comprising:
determining a vehicle reference; and
moving a user interface with respect to the vehicle reference such that the user interface is aligned with a vehicle window opening.

12. The method as recited in claim 11, wherein determining the vehicle reference comprises moving a sensor that identifies the vehicle reference and moving the user interface in coordination with the user interface.

13. The method as recited in claim 11, wherein determining the vehicle reference comprises moving a sensor that follows the vehicle reference and moving the user interface in coordination with the user interface.

14. The method as recited in claim 11, wherein the vehicle reference comprises a hood line.

15. The method as recited in claim 11, wherein determining the vehicle reference comprises at least one of visual, infrared, sonar, and radar.

16. The method as recited in claim 11, wherein moving the user interface comprises moving the user interface with respect to a stationary cabinet that at least partially forms a kiosk.
